(19) United States
(12) Patent Application Publication
(10) Pub. No.: US 2016/0112864 A1
(43) Pub. Date: Apr. 21, 2016

(54) PROACTIVE TRANSFER OF NETWORK SERVICES DATA USING NETWORK MAP DATA

(71) Applicant: TOYOTA JIDOSHA KABUSHIKI KAISHA, Toyota-shi (JP)

(72) Inventor: Dustin HARBER, Santa Clara, CA (US)

(21) Appl. No.: 14/515,722

(22) Filed: Oct. 16, 2014

(51) Int. Cl. H04W 8/12; H04W 68/04; H04W 4/02

(52) U.S. Cl. CPC H04W 8/12; H04W 4/028; H04W 68/04

(57) ABSTRACT

The disclosure includes a system and method for proactively providing the transfer of network services data using network map data. The system includes a processor and a memory storing instructions that, when executed, cause the system to: estimate a present journey for a user based on time synchronicity data and historical journey data; determine one or more preferred network services for the user based on preference hierarchy data; determine that a mobile system associated with the user will enter a dead zone based on the estimation of the present journey and network map data describing the dead zone; determine network services data configured to enable the mobile system to consume the preferred network services while in the dead zone; and transmit a request for network services data configured to enable the mobile system to consume the preferred network services while in the dead zone.

### BACKGROUND

The specification relates to proactively transferring network services data. In particular, the specification relates to proactively transferring network services data using network map data.

Users of vehicles consume various network services. The network services are provided using network services data that are wirelessly transmitted to the vehicles. Wireless transmission of network services data may require the vehicles to have access to a wireless network along the roadway. However, the roadway has dead zones in which wireless networks are not accessible. As a result, there may be periods of time when vehicles are not able to provide network services to users.

### SUMMARY

According to one innovative aspect of the subject matter described in this disclosure, a system for proactively providing the transfer of network services data using network map data includes a processor and a memory storing instructions that, when executed, cause the system to: estimate a present journey for a user based on time synchronicity data and historical journey data; determine one or more preferred network services for the user based on preference hierarchy data; determine that a mobile system associated with the user will enter a dead zone based on the estimation of the present journey and network map data describing the dead zone, wherein the dead zone is a geographic area having limited connectivity to a mobile data network; determine network services data configured to enable the mobile system to consume the one or more preferred network services while in the dead zone; and transmit a request for network services data configured to enable the mobile system to consume the one or more preferred network services while in the dead zone.

In general, yet another innovative aspect of the subject matter described in this disclosure may be embodied in methods that include: estimating a present journey for a user based on time synchronicity data and historical journey data; determining one or more preferred network services for the user based on preference hierarchy data; determining that a mobile system associated with the user will enter a dead zone based on the estimation of the present journey and network map data describing the dead zone, wherein the dead zone is a geographic area having limited connectivity to a mobile data network; determining network services data configured to enable the mobile system to consume the one or more preferred network services while in the dead zone; and transmitting a request for network services data configured to enable the mobile system to consume the one or more preferred network services while in the dead zone.

In general, yet another innovative aspect of the subject matter described in this disclosure may be embodied in a computer program product comprising a non-transitory computer-usable medium including a computer-readable program, wherein the computer-readable program when executed on a computer causes the computer to: estimate a present journey for a user based on time synchronicity data and historical journey data; determine one or more preferred network services for the user based on preference hierarchy data; determine that a mobile system associated with the user will enter a dead zone based on the estimation of the present journey and network map data describing the dead zone, wherein the dead zone is a geographic area having limited connectivity to a mobile data network; determine network services data configured to enable the mobile system to consume the one or more preferred network services while in the dead zone; and transmit a request for network services data configured to enable the mobile system to consume the one or more preferred network services while in the dead zone.

Other aspects include corresponding methods, systems, apparatus, and computer program products for these and other innovative aspects.

These and other implementations may each optionally include one or more of the following operations and features. For instance, the features may include: the historical journey data is associated with the user and describes one or more prior journeys taken by the user; the historical journey data is associated with the user and the mobile system downloads the historical journey data for the user from a network; the mobile system is one of a vehicle, a robot, a drone, a smartphone, a laptop, a tablet computing device, and a connected device; the preference hierarchy data describes which network services the user is estimated to prefer for the time of day indicated by the time synchronicity data; and the preference hierarchy data describes which network services the user is estimated to prefer for the present journey.

For instance, the operations may include determining that the user is on a phone call and providing the user with an indication that the mobile system will travel into a dead zone during the present journey, the indication provided before the mobile system enters the dead zone.

In general, the operations may further include: determining that the mobile system is providing graphical navigation instructions; generating graphical data configured to depict one or more dead zones for a geographical region associated with the graphical navigation instructions, wherein the graphical data is generated responsive to determining that the mobile system will enter a dead zone; and providing a graphical representation of the one or more dead zones as a component of the graphical navigation instructions.

In general, the operations may further include: detecting the presence of one or more nearby mobile systems responsive to determining that the mobile system will enter a dead zone; building an ad-hoc mesh network including the mobile system and the detected nearby mobile systems; and transmitting network services data among entities of the ad-hoc mesh network, the transmission enabling the entities of the ad-hoc mesh network that are in the dead zone to continue receiving network services data while in the dead zone.

In general, the operations may further include providing navigation instructions configured to minimize a journey duration in a dead zone responsive to determining that the mobile system will enter a dead zone.

Throughout the disclosure, the term “data” may be used to represent any digital data undergoing the transfer functions or operations described herein. The digital data may include, but is not limited to, network services data, network map data, journey data, user profile data, time synchronicity data, historical journey data, preference hierarchy data, dead zone data, navigation map data, mesh network data, velocity data, data to be shared between two or more entities (e.g., servers, vehicle systems, mobile client devices, client devices, etc.) and data to be transferred between two or more entities.

The disclosure is particularly advantageous in a number of respects. For example, the system may enable a mobile system to enter a dead zone and continue to receive network services data. The network services data may then enable the mobile system to continue to provide network services (e.g., navigation, infotainment, etc.) while the mobile system is in the dead zone. In general, the system may enable the mobile system to provide an indication or a warning to a user of the mobile system before the mobile system enters a dead zone. The indication or warning may include a graphical representation of the one or more dead zones as a component of graphical navigation instructions provided to the user. In general, the system may further enable the mobile system to provide navigation instructions that are configured to minimize a journey duration in a dead zone.

The advantages of the system described herein are provided by way of example, and the system may have numerous other advantages.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram illustrating an example system for proactively transferring network services data.

FIG. 2 is a block diagram illustrating an example system that includes an example map module.

FIG. 3 is a block diagram illustrating an example system that includes an example transfer module.

FIG. 4 is a flowchart of an example method for determining network map data describing one or more wireless network signals in a geographic region.

FIG. 5 is a flowchart of an example method for determining preference hierarchy data.

FIGS. 6A and 6B are a flowchart of an example method for proactively transferring network services data using network map data.

FIG. 7 is a flowchart of an example method for providing a user with an indication that a mobile system will travel into a dead zone during a present journey.

FIG. 8 is a flowchart of an example method for providing a graphical representation depicting a dead zone for a geographic region overlaying present graphical navigation guidance requested by a user.

FIG. 9 is a flowchart of an example method for providing network services data via an ad-hoc mesh network.

FIG. 10 is a flowchart of an example method for suggested navigation instructions configured to minimize journey duration in a dead zone.

### DETAILED DESCRIPTION

### System Overview

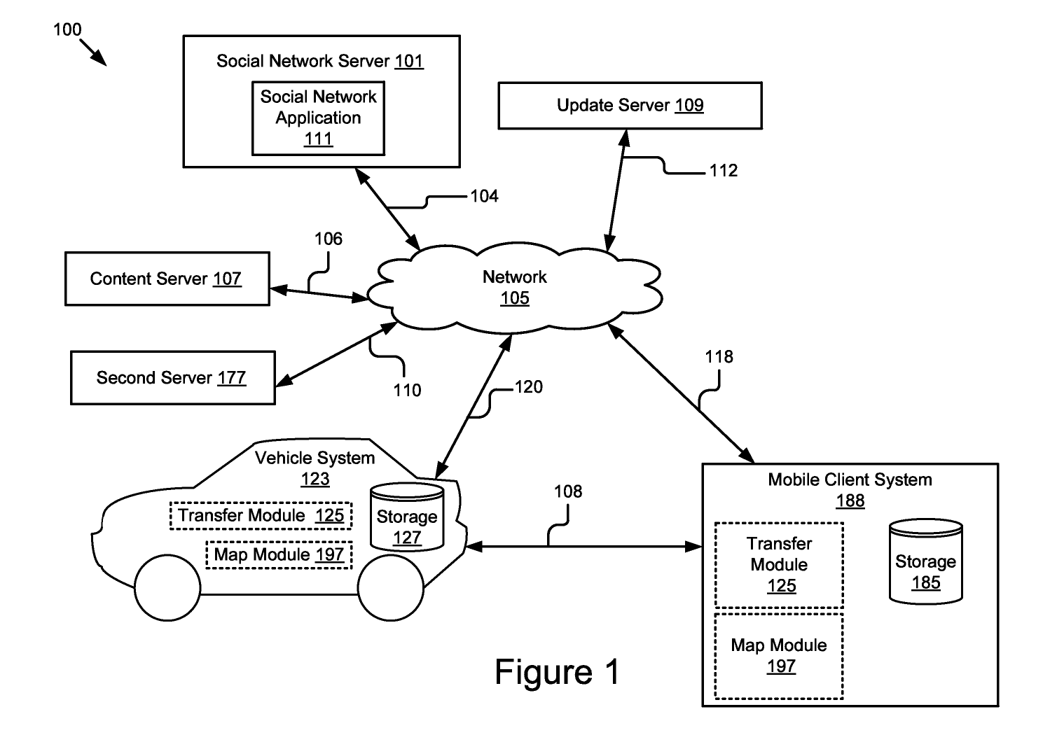

FIG. 1 illustrates a block diagram of some implementations of a system 100 for proactively transferring network services data. The system 100 includes a social network server 101, an update server 109, a mobile client system 188, a vehicle system 123, a second server 177, and a content server 107. The system 100 may include other servers or devices not shown in FIG. 1 including, for example, a traffic server for providing traffic data, a weather server for providing weather data, and a map server for providing map data, etc. The system 100 may further include a global positioning system (“GPS”) satellite communicatively coupled to the vehicle system 123 or the mobile client system 188 for providing any combination of graphical and audio GPS navigation instructions.

In some implementations, these entities of the system 100 may be communicatively coupled via a network 105. For example, the social network server 101 may be communicatively coupled to the network 105 via a signal line 104. The update server 109 may be communicatively coupled to the network 105 via a signal line 112. The mobile client system 188 may be communicatively coupled to the network 105 via a signal line 118. The second server 177 may be communicatively coupled to the network 105 via a signal line 110. The content server 107 may be communicatively coupled to the network 105 via a signal line 106. The vehicle system 123 may be communicatively coupled to the network 105 via a signal line 120.

While FIG. 1 illustrates one social network server 101, one update server 109, one mobile client system 188, one vehicle system 123, one second server 177, and one content server 107, the disclosure applies to a system architecture including one or more social network servers 101, one or more update servers 109, one or more mobile client systems 188, one or more vehicle systems 123, one or more second servers 177, and one or more content servers 107. Furthermore, although FIG. 1 illustrates one network 105 coupled to the entities of the system 100, in practice one or more networks 105 of various types may be connected to these entities.

The network 105 can be a conventional type, wired or wireless, and may have numerous different configurations including a star configuration, a token ring configuration, or other configurations. Furthermore, the network 105 may include a local area network (LAN), a wide area network (WAN) (e.g., the Internet), or other interconnected data paths across which multiple devices may communicate. In some implementations, the network 105 may be a peer-to-peer network. The network 105 may also be coupled to or includes portions of a telecommunications network for sending data in a variety of different communication protocols. In some implementations, the network 105 includes Bluetooth® communication networks or a cellular communications network for sending and receiving data including via short messaging service (SMS), multimedia messaging service (MMS), hypertext transfer protocol (HTTP), direct data connection, WAP, e-mail, etc. In some implementations, the network 105 may include a GPS satellite for providing GPS navigation to the vehicle system 123 or the mobile client system 188. The network 105 may be a mobile data network such as 3G, 4G, long term evolution (LTE), Voice-over-LTE (“VoLTE”), or any other mobile data network or combination of mobile data networks. In some implementations, the network 105 may be a combination of different networks.

The mobile client system 188 may be a mobile computing device that includes a memory and a processor, for example, a laptop computer, a desktop computer, a tablet computer, a mobile telephone, a personal digital assistant (“PDA”), a mobile e-mail device, a portable game player, a portable music player, a connected device or wearable computer (e.g., a smartwatch, smart glasses, fitness tracker, etc.), a television with one or more processors embedded therein or coupled thereto, or other electronic device capable of accessing the network 105. A user may interact with the mobile client system 188. The mobile client system 188 may be communicatively coupled to the vehicle system 123 via a signal line 108. The signal line 108 may be a hard wired or wireless communicative coupling between the mobile client system 188 and the vehicle system 123. In some implementations, the vehicle system 123 may access the network 105 at least in part via the mobile client system 188. In some implementations, the mobile client system 188 may be a device similar to the vehicle system 123.

The mobile client system 188 may include functionality to enable a user to consume network services. The network services may include any service accessible via the network 105. For example, the network services include navigation instructions, streaming audio or video (such as Pandora™, Spotify™, iTunes™, Google Play™, YouTube™, etc.), social networking (such as Facebook™, Google+™, LinkedIn™, Tinder™, QQ™, etc.), microblogging (such as Twitter™, Tumblr™, etc.), online chatting (such as Snapchat™, WhatsApp™, etc.), online content sharing (such as Instagram™, Pinterest™, etc.), e-mail (such as Gmail™, Outlook™, Yahoo! Mail™, etc.), file sharing (such as Dropbox™, Google Drive™, MS OneDrive™, Evernote™, etc.), calendar and scheduling (such as Google™ Calendar, MS Outlook™, etc.), etc.

The mobile client system 188 may include a map module 197, a transfer module 125, and a storage 185. The map module 197 and the transfer module 125 are depicted in dashed lines in FIG. 1 in order to indicate that they are optional features of the mobile client system 188. For example, one or more of the map module 197 and the transfer module 125 may be present in the vehicle system 123, the update server 109, or any other component of the system 100.

The map module 197 may include code and routines for determining network map data describing the mobile network coverage area and one or more dead zones for a geographic area. For example, the network map data describes the availability of a mobile data network such as 3G, 4G, LTE, Voice-over-LTE (“VoLTE”), or any other mobile data network or combination of mobile data networks in a geographic area. In one implementation, the network map data may describe the mobile network coverage area and one or more dead zones along the roadways of a geographic area. For example, the network map data only describes the availability of a mobile network along the roadways of a geographic area, and does not describe the availability of the mobile network when the mobile communication node is not on the roadway.

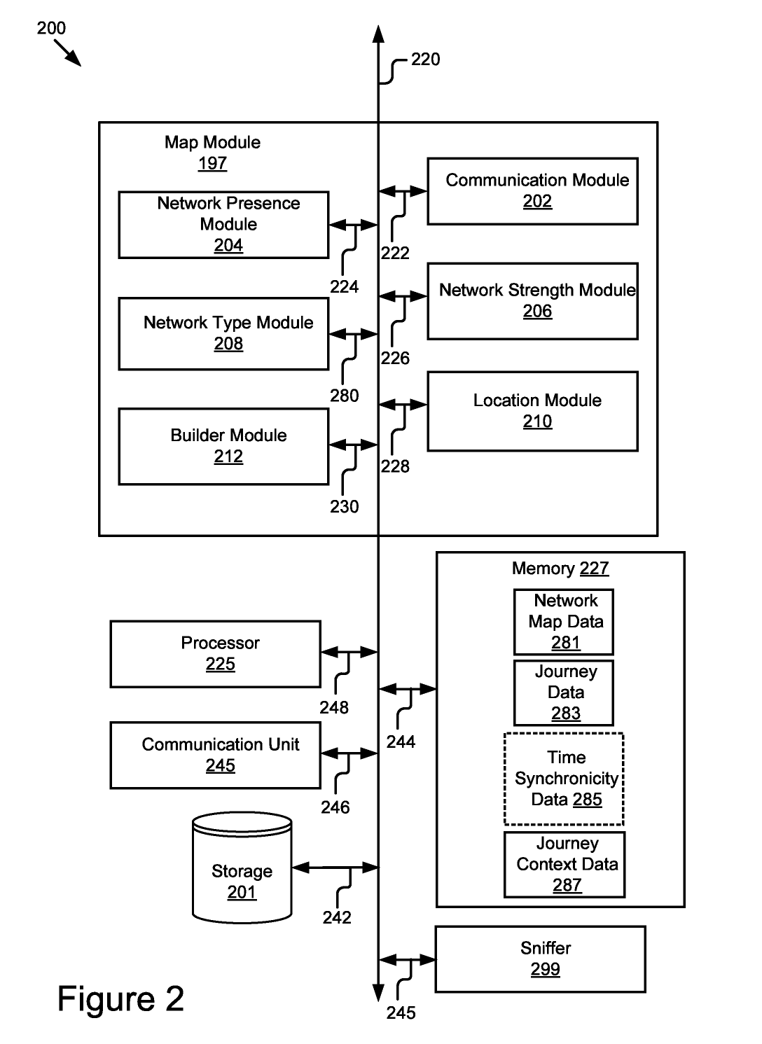

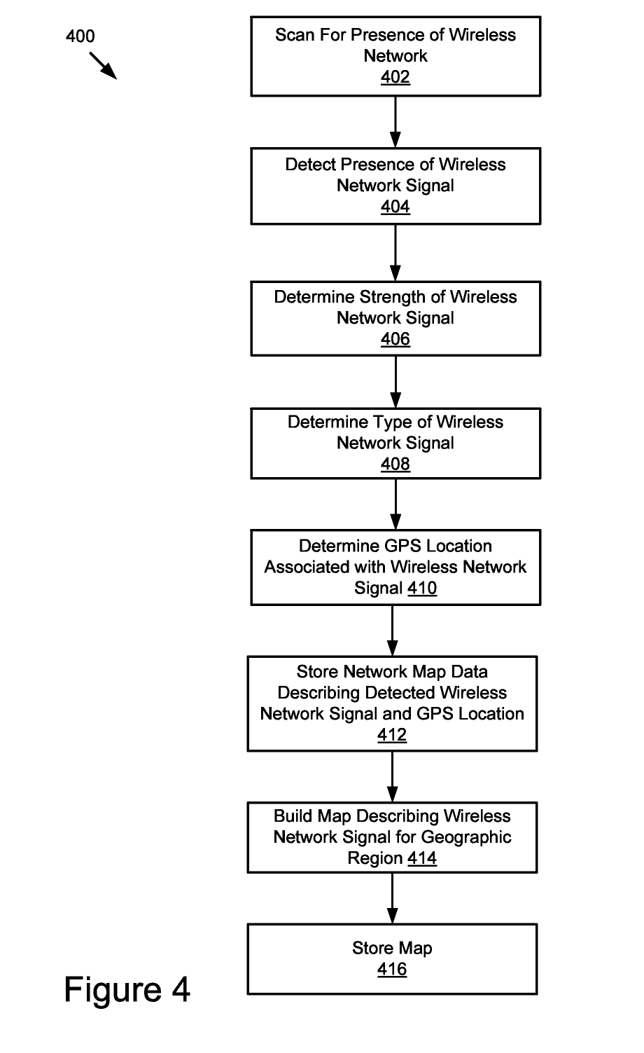

In some implementations, the map module 197 can be implemented using hardware including a field-programmable gate array (“FPGA”) or an application-specific integrated circuit (“ASIC”). In some other implementations, the map module 197 can be implemented using a combination of hardware and software. The map module 197 may be stored in a combination of the devices and servers, or in one of the devices or servers. The map module 197 is described in more detail below with reference to FIGS. 2 and 4.

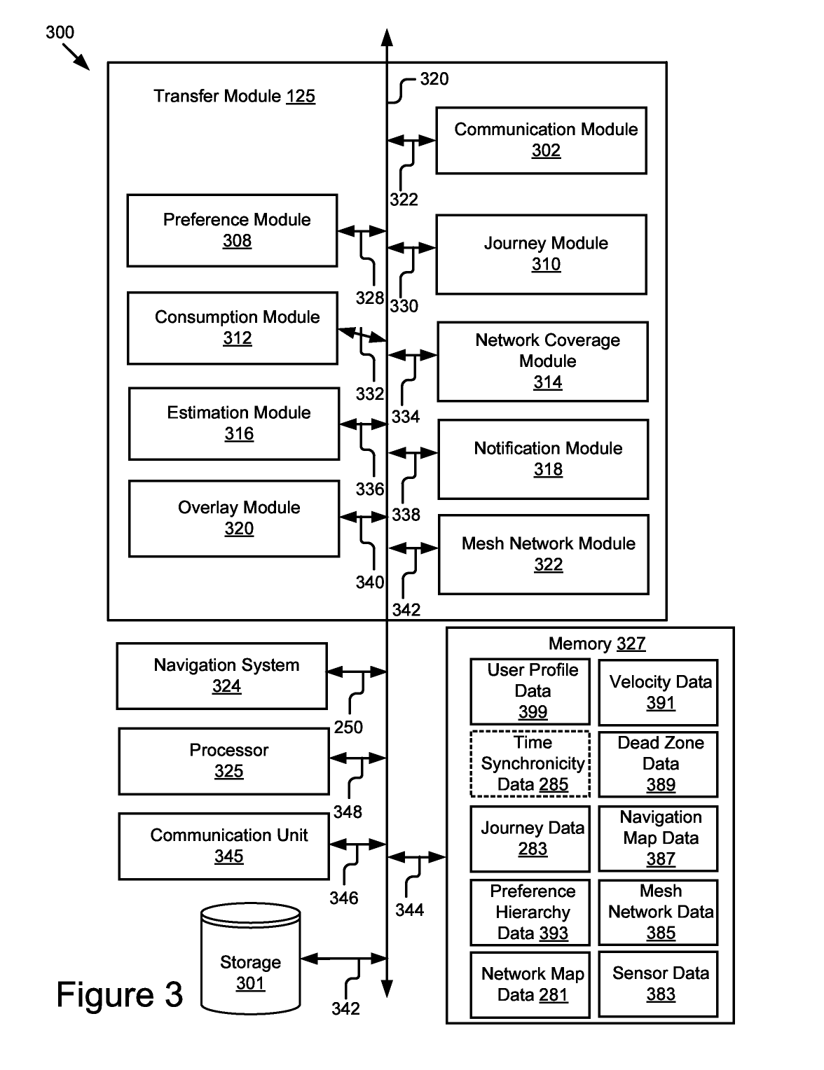

The transfer module 125 may include code and routines for proactively transferring network services data before a mobile system enters a dead zone. The mobile system may include the vehicle system 123 or the mobile client system 188. The transfer module 125 may include functionality for taking action responsive to determining that the mobile system is going to enter the dead zone. In some implementations, the transfer module 125 can be implemented using hardware including a field-programmable gate array (“FPGA”) or an application-specific integrated circuit (“ASIC”). In some other implementations, the transfer module 125 can be implemented using a combination of hardware and software. The transfer module 125 may be stored in a combination of the devices and servers, or in one of the devices or servers. The transfer module 125 is described in more detail below with reference to FIGS. 3 and 5-10.

The storage 185 can be a non-transitory storage medium that stores data for providing the functionality described herein. The storage 185 may be a dynamic random access memory (DRAM) device, a static random access memory (SRAM) device, flash memory, or some other memory devices. In some implementations, the storage 185 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

In some implementations, the mobile client system 188 may be a smartphone accessing the network 105. The network 105 may be a mobile data network as described above. A user of the mobile client system 188 may be accessing the network 105 to enable a user of the mobile client system 188 to consume one or more network services. The mobile client system 188, or the network service itself, may be configured so that the mobile client system 188 must have access to network services data in order to provide the user with network services. For example, the mobile client system 188 receives network services data via the network 105 and uses the network services data to provide the network services to the user. The network services data may be any digital data used to provide network services to a user. The user may be approaching a dead zone. While in the dead zone, the mobile client system 188 is unable to access the network 105 and retrieve network services data to enable the mobile client system 188 to continue providing the network services to the user. As will be described in more detail below with reference to FIGS. 2-10, the transfer module 125 may access the network map data generated by the map module 197 to determine that the mobile client system 188 is going to enter the dead zone. The transfer module 125 may take action responsive to determining that the mobile client system 188 is going to enter the dead zone. For example, the transfer module 125 may retrieve sufficient network services data via the network 105 to enable the mobile client system 188 to continue providing the network services. The transfer module 125 may take other actions responsive to determining that the mobile client system 188 is going to enter the dead zone. For example, the transfer module 125 may provide a warning or notification to the user or suggest an alternative route so that the mobile client system 188 does not enter the dead zone. The transfer module 125 may take other actions responsive to determining that the mobile client system 188 is going to enter the dead zone. The actions taken by the transfer module 125 are described in more detail below with reference to FIGS. 4 and 6A-10.

The vehicle system 123 may be a mobile communication node. For example, the vehicle system 123 may be a vehicle (e.g., an automobile, a bus, an airplane, a boat), a robot, a drone, a bionic implant, or any other mobile system. In some implementations, the vehicle system 123 may include a computing device that includes a memory and a processor. A user may interact with the vehicle system 123. In some implementations, the vehicle system 123 may include a mobile client device. For example, the vehicle system 123 may include a tablet, a smartphone, an infotainment system, or another type of computing device.

The vehicle system 123 may include hardware or software to enable the vehicle system 123 to wirelessly access the network 105. For example, the vehicle system 123 may include an infotainment system to provide network services to a user of the vehicle system 123. The vehicle system 123 may receive network services data via the network 105. The infotainment system of the vehicle system 123 may use the network services data to provide one or more network services to the user.

In some implementations, the vehicle system 123 may include one or more sensors (not shown), such as a navigation sensor (e.g., a GPS sensor), an infrared detector, a motion detector, a thermostat, a sound detector, and any other type of sensors. For example, the vehicle system 123 may include sensors for measuring one or more of a current time, a current location (e.g., a latitude, longitude, and altitude of a location), an acceleration of the vehicle system 123, a velocity of the vehicle system 123, a fuel tank level of the vehicle system 123, a battery level of the vehicle system 123, an activity of an occupant of the vehicle system 123, etc. The sensors of the vehicle system 123 may include an interior cabin camera, a weight sensor, a carbon monoxide sensor, or any other sensor to detect the activity of the occupant of the vehicle system 123. The sensors of the vehicle system 123 may include a buffer or some other non-transitory memory to store the network services requested by the user of the vehicle system 123.

As illustrated in FIG. 1, the vehicle system 123 includes the transfer module 125, the map module 197, and a storage 127. The transfer module 125 and the map module 197 are depicted in FIG. 1 with a dashed line to indicate that they are optional features of the vehicle system 123. The transfer module 125 and the map module 197 are described above with reference to the mobile client system 188, and so that description will not be repeated here.

The storage 127 can be a non-transitory storage medium that stores data for providing the functionality described herein. The storage 127 may be a dynamic random access memory (DRAM) device, a static random access memory (SRAM) device, flash memory, or some other memory devices. In some implementations, the storage 127 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

The social network server 101 can be a hardware server that includes a processor, a memory, and network communication capabilities. The social network server 101 sends and receives data to and from other entities of the system 100 via the network 105. The social network server 101 includes a social network application 111. A social network can be a type of social structure where the users may be connected by a common feature. The common feature includes relationships/connections, e.g., friendship, family, work, an interest, etc. The common features may be provided by one or more social networking systems including explicitly defined relationships and relationships implied by social connections with other online users, where the relationships form a social graph. In some examples, the social graph can reflect a mapping of these users and how they can be related.

The social network server 101 and the social network application 111 can be representative of one social network, and there may be multiple social networks coupled to the network 105, each having its own server, application, and social graph. For example, a first social network may be more directed to business networking, a second may be more directed to or centered on academics, a third may be more directed to local business, a fourth may be directed to dating, and others may be of general interest or a specific focus.

The content server 107 can be a hardware server that includes a processor, a memory, and network communication capabilities. The content server 107 may send and receive data to and from other entities of the system 100 via the network 105. In some implementations, the content server 107 may provide various services to the vehicle system 123 or the mobile client system 188. For example, the content server 107 may provide one or more of the network services described above. In some implementations, the content server 107 sends the network services data to the vehicle system 123 or the mobile client system 188. In some implementations, the content server 107 sends network services data to the mobile client system 188, causing the mobile client system 188 to forward the network services data to the vehicle system 123.

The update server 109 can be a hardware server that includes a processor, a memory, and network communication capabilities. The update server 109 may send and receive data to and from other entities of the system 100 via the network 105. For example, the update server 109 updates the journey data, historical journey data, time synchronicity data, or network services data stored on the vehicle system 123 or the mobile client system 188.

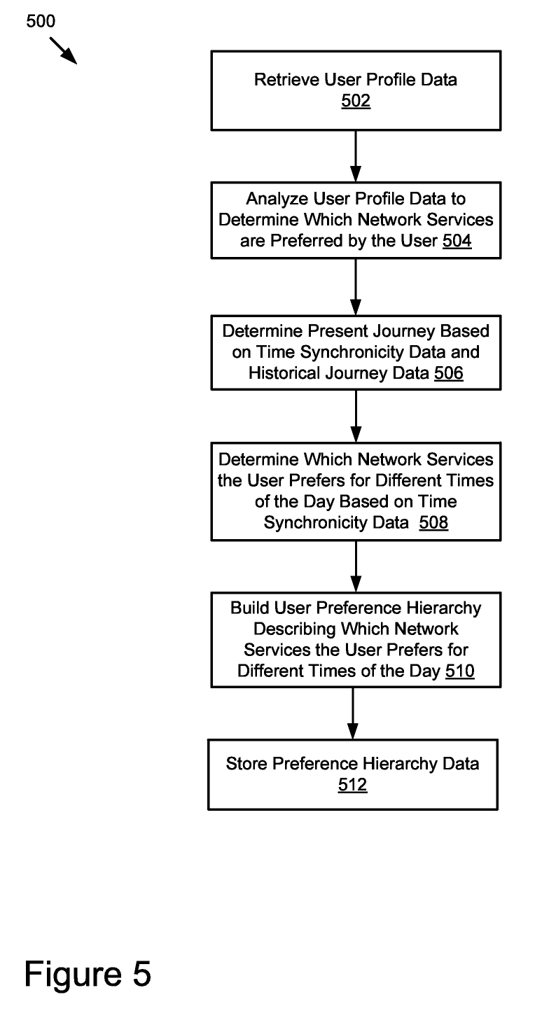

In some implementations, the update server 109 may be a hardware cloud server that monitors the geographic location of the vehicle system 123 or the mobile client system 188. The update server 109 may store network map data. The update server 109 may include the transfer module 125. The transfer module 125 of the update server 109 may determine that the vehicle system 123 (or the mobile client system 188) is going to enter a dead zone. The transfer module 125 may retrieve network services data via the network 105. The transfer module 125 may transmit the network services data to the vehicle system 123 or the mobile client system 188 via the network 105 to enable the vehicle system 123 (or the mobile client system 188) to continue providing a network service to the user while traveling through the dead zone. In implementations where the transfer module 125 is a component of the update server 109, the transfer module 125 may provide other functionality as described below with reference to FIGS. 5-10. In this way the transfer module 125 may be deployed as a cloud service to the vehicle system 123 or the mobile client system 188.

The second server 177 can be a hardware server that includes a processor, a memory, and network communication capabilities. The second server 177 sends and receives data to and from other entities of the system 100 via the network 105. For example, the second server 177 sends data describing a user's calendar to the mobile client system 188 with permission from the user. The second server 177 may provide any of the network services described above.

In some implementations, the second server 177 may include code and routines for providing a weather service to the vehicle system 123 or the mobile client system 188. For example, the second server 177 provides weather data that describes a current weather condition for a geographic area or an estimate of a future weather condition for the geographic area. The weather data indicates real-time weather conditions. In some implementations, the weather data indicates a storm advisory or any other similar weather advisory.

In some implementations, the second server 177 may include code and routines for providing a traffic advisory service to the vehicle system 123 or the mobile client system 188. The traffic advisory service may provide traffic advisory data describing a traffic condition along a roadway for a geographic area.

The traffic condition may be a dynamic condition or a static condition. An example of a dynamic traffic condition may include traffic congestion, a traffic accident, an animal or other obstacle along a roadway, or any other condition that may change within 1 to 24 hours of the traffic advisory data being transmitted by the second server 177 to the vehicle system 123 or the mobile client system 188 via the network 105. Dynamic traffic conditions may also include a speed trap, DUI inspection point, or any other condition caused by law enforcement activity along a roadway.

A static traffic condition may include any traffic condition that may not change within 24 hours of the traffic advisory data being transmitted by the second server 177 to the vehicle system 123 or the mobile client system 188 via the network 105. A static traffic condition may include a portion of a roadway with a history of high instances of traffic accidents, traffic citations among motorists, poor drivability for current weather conditions, or any other traffic condition that may not change within 24 hours of the traffic advisory data being transmitted by the second server 177 to the vehicle system 123 or the mobile client system 188 via the network 105.

In the implementations described above, the code and routines of the second server 177 may be stored on a memory of the second server 177 or executed by a processor of the second server 177.

### Example Map Module

Referring now to FIG. 2, an example of the map module 197 is shown in more detail. FIG. 2 is a block diagram of an example system 200. The system 200 may be the vehicle system 123, the mobile client system 188, or one of the servers 101, 107, 109, 177 of the system 100. The system 200 includes the map module 197, a processor 225, a communication unit 245, a storage 201, a memory 227, and a sniffer 299 according to some examples. The components of the system 200 are communicatively coupled by a bus 220.

The processor 225 includes an arithmetic logic unit, a microprocessor, a general-purpose controller, or some other processor array to perform computations and provide electronic display signals to a display device. The processor 225 is coupled to the bus 220 for communication with the other components via a signal line 248. The processor 225 processes data signals and may include various computing architectures including a complex instruction set computer (CISC) architecture, a reduced instruction set computer (RISC) architecture, or an architecture implementing a combination of instruction sets. Although FIG. 2 includes a single processor 225, multiple processors 225 may be included. Other processors, operating systems, sensors, displays, and physical configurations may be possible.

In some embodiments, the system 200 may include code and routines configured to perform or control performance of one or more steps of the methods 400, 500, 600, 700, 800, 900, 1000 described below with reference to FIGS. 4-10 when executed by the processor 225. In some embodiments, the system 200 may be a special purpose processor-based computing device programmed to execute one or more steps of the methods 400, 500, 600, 700, 800, 900, 1000 described below with reference to FIGS. 4-10 when executed by the processor 225.

The memory 227 stores instructions or data that may be executed by the processor 225. The memory 227 is coupled to the bus 220 for communication with the other components via a signal line 244. The instructions or data may include code for performing the techniques described herein. The memory 227 may be a dynamic random access memory (DRAM) device, a static random access memory (SRAM) device, flash memory, or some other memory device. In some implementations, the memory 227 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

In some embodiments, the memory 227 is a tangible or non-transitory memory communicatively coupled to the processor 225. The memory 227 may store code and routines that may be executed by the processor 225. For example, the memory 227 may store one or more modules 202, 204, 206, 208, 210, 212 of the map module 197 which may be executed by the processor 225.

As illustrated in FIG. 2, the memory 227 stores network map data 281, journey data 283, time synchronicity data 285, and journey context data 287. The time synchronicity data 285 is depicted with a dashed line in FIG. 2 to indicate that it is an optional feature of the system 200. The memory 227 may also store other data for providing the functionality described herein.

The network map data 281 may include, but is not limited to, digital data describing the mobile network coverage area and one or more dead zones for a geographic area. For example, the network map data describes the availability of one or more mobile data networks in a geographic area. In one implementation, the network map data 281 may describe the mobile network coverage area and one or more dead zones along the roadways of a geographic area.

The journey data 283 may include historical journey data. This historical journey data may be associated with a user of the vehicle system 123 or the mobile client system 188. The historical journey data may include data describing information such as routes, start points, destinations, durations, departure times, arrival times, directions, etc. associated with historical journeys. For example, the journey data 283 may include a log of all locations visited by the vehicle system 123, the mobile client system 188, or a user of both the vehicle system 123 and the mobile client system 188 (e.g., locations associated with both the vehicle system 123 and the mobile client system 188 having a common user). The journey data 283 may describe locations requested by the user via a navigation system of the vehicle system 123 or the mobile client system 188.

The journey data 283 may include information describing one or more users associated with the vehicle system 123 (e.g., a driver in a vehicle, a passenger in the vehicle), historical journey data associated with a user operating the vehicle (e.g., start points, destinations, durations, routes associated with historical journeys), and other vehicle data associated with the vehicle system 123.

The journey data 283 may include the network map data 281. For example, the journey data 283 may include information describing the mobile network coverage area and one or more dead zones along the roadways of a geographic area associated with a journey start point, destination, or a route for traveling from a start point to a destination. In this way, the map module 197 may beneficially modify the journey data 283 to include relevant information from the network map data 281 so that the transfer module 125 may perform more computationally efficient operations using the journey data 283, as described in more detail below with reference to FIGS. 3 and 6A-10.

The time synchronicity data 285 may include information describing a universal time shared among one or more systems 200 associated with the network 105 of FIG. 1. The time synchronicity data 285 may be data used to synchronize a system time with a universal time. For example, the time synchronicity data can be configured to synchronize a local time associated with the vehicle system 123 or the mobile client system 188 with a universal time. In some implementations, a local time may be synchronized with the Coordinated Universal Time (UTC) defined by International Telecommunications Union Recommendation (ITU-R TF.460-6) according to a corresponding local time zone. In some other implementations, a local time may be synchronized by timekeeping technologies including GPS satellites and a network time protocol (NTP). The network time protocol may include a networking protocol for clock synchronization between computer systems over packet-switched variable-latency data networks.

The journey data 283 may include the time synchronicity data 285 or be associated with the time synchronicity data 285. For example, the time synchronicity data 285 may describe one or more times associated with one or more historic journeys described by the journey data 283. In some embodiments, the time synchronicity data 285 may indicate that a particular user has a pattern of taking a particular journey at a particular time of day for a given day of the week. For example, the combination of the time synchronicity data 285 and the journey data 283 may indicate that a user has a pattern of beginning their commute to work at 7:00 AM on most weekdays (Monday through Friday).

In some examples, the memory 227 may store the journey context data 287. The journey context data 287 may include information indicating why some journeys happen at a particular time. The journey context data 287 may also indicate why some journeys fail to happen at a particular time when the journey may have otherwise occurred. For example, the combination of the time synchronicity data 285, the journey data 283, and the journey context data 287 may indicate that a user has a pattern of beginning their commute to work at 7:00 AM on most weekdays (Monday through Friday) with the exception that the user does not take this journey when the weekday is a holiday such as Christmas or the Fourth of July. In this example, the journey context data 287 may provide context information to describe one or more exceptions to the pattern indicated by the journey data 283 and the time synchronicity data 285.

In some implementations, the journey context data 287 includes weather data associated with a journey. For example, the combination of the time synchronicity data 285 and the journey data 283 may indicate that a user has the following pattern: (1) departing for work at 7:00 AM on most weekdays (Monday through Friday); and (2) arriving at work at 7:30 AM on these days. The journey context data 287 may indicate that the user breaks this pattern for certain weather conditions. For example, the journey context data 287 may indicate that the user arrives at work at 7:45 AM when the weather conditions include rain or 8:00 AM when the weather conditions include snow or ice. The journey context data 287 may provide context information to describe one or more exceptions to the pattern indicated by the journey data 283 and the time synchronicity data 285. For example, the user may be on the roadway for different times because of the weather conditions (instead of being on the roadway from 7:00 AM to 7:30 AM, the user is on the roadway from 7:00 AM to 7:45 AM or 8:00 AM depending on the type of weather condition present). Because the user is on the roadway for different times, and because the availability or strength of mobile data networks may be different for different times or different weather conditions, the network map data 281 for a journey affected by weather may be different than a similar journey that is not affected by weather. Other examples of the journey context data 287 are possible.

In some implementations, the time synchronicity data 285 may describe one or more times associated with the network map data 281. For example, the availability or strength of one or more mobile data networks for a particular geographic area may change over time. The network map data 281 may describe the availability or strength of one or more mobile data networks for a particular geographic area over various times. In this way, the combination of the network map data 281 and the time synchronicity data 285 may indicate the historic availability and strength of a mobile network for a particular geographic area at various times of day. For example, the network map data 281 and the time synchronicity data 285 may be combined to estimate the availability and strength of a mobile data network along a roadway in a geographic area for a particular time of day.

The journey data 283 may be associated with a user of the vehicle system 123 or the mobile client system 188. For example, the journey data 283 may be specific to a particular user of the vehicle system 123 or the mobile client system 188. In this way, the journey data 283 may be distinguished from navigation map data used to provide GPS coordinates or navigation instructions by a navigation system. For example, the same navigation map data may be used to provide GPS coordinates or navigation instructions for any user of the vehicle system 123 or the mobile client system 188. By contrast, the journey data 283 may describe historic journeys for a particular user and include the time synchronicity data 285, the journey context data 287 or the network map data 281 describing one or more historic journeys of the user.

In some embodiments, the network map data 281 may include the time synchronicity data 285 or weather data. For example, the network map data 281 may indicate the availability and strength for a geographic region at different times of day indicated by the time synchronicity data 285 or different weather conditions indicated by the weather data.

The communication unit 245 transmits and receives data to and from at least one of the vehicle system 123, the mobile client system 188, and the servers 101, 107, 109, 177 in the system 100. The communication unit 245 is coupled to the bus 220 via a signal line 246. In some implementations, the communication unit 245 includes a port for direct physical connection to the network 105 or to another communication channel. For example, the communication unit 245 includes a USB, SD, CAT-5, or similar port for wired communication with other entities in the system 100. In some implementations, the communication unit 245 includes a wireless transceiver for exchanging data with other entities in the system 100 or other communication channels using one or more wireless communication methods, including IEEE 802.11, IEEE 802.16, Bluetooth®, or another suitable wireless communication method.

In some implementations, the communication unit 245 includes a cellular communications transceiver for sending and receiving data over a cellular communications network including via short messaging service (SMS), multimedia messaging service (MMS), hypertext transfer protocol (HTTP), direct data connection, WAP, e-mail, or another suitable type of electronic communication. In some implementations, the communication unit 245 includes a wired port and a wireless transceiver. The communication unit 245 also provides other conventional connections to the network 105 for distribution of files or media objects using standard network protocols including TCP/IP, HTTP, HTTPS, and SMTP, etc.

The storage 201 stores instructions or data that may be executed by the processor 225. The storage 201 may be a buffer used by the system 200 to provide its functionality. The storage 201 is coupled to the bus 220 for communication with the other components via a signal line 242. The instructions or data stored on the storage 201 may include code for performing the techniques described herein. The storage 201 may be a dynamic random access memory (DRAM) device, a static random access memory (SRAM) device, flash memory, or some other memory device. In some implementations, the storage 201 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

The sniffer 299 may be a packet analyzer. The sniffer 299 may be a packet analyzer for scanning and detecting the presence of a wireless network. For example, the sniffer 299 may be a packet analyzer for scanning and detecting the presence of a mobile network signal. In some implementations, the sniffer 299 is software, hardware, or a combination of hardware and software. For example, the sniffer 299 is code and routines stored on the storage 201 or the memory 227 and executable by the processor 225. The sniffer 299 may be a wireless sniffer. The sniffer 299 may include hardware components such as an antenna or a packet capture appliance.

The sniffer 299 may be configured to detect the presence of a mobile network in a geographic region. For example, the sniffer 299 may be configured to detect the presence of a mobile network along a roadway. The sniffer 299 may also be configured to detect a dead zone along a roadway. The sniffer 299 may be configured to detect one or more mobile networks such as those described above with reference to the network 105 of FIG. 1. The sniffer 299 may include functionality to intercept and log traffic on a mobile network detected by the sniffer 299. The sniffer 299 may store data describing the traffic and may be stored on the storage 201 or the memory 227. In some implementations, the sniffer 299 includes functionality to determine the type of mobile network detected by the sniffer 299. For example, the sniffer 299 may be able to discern the difference between the signal for a Bluetooth® network and the signal for a 4G network. In some implementations, the sniffer 299 includes functionality to determine the strength of the signal associated with the mobile network. The sniffer 299 may include other functionality not described here.

The sniffer 299 may be communicatively coupled to the bus 220 via a signal line 243. The sniffer 299 may transmit digital data describing the mobile network coverage area and one or more dead zones for a geographic area to the communication unit 245. The communication unit 245 may transmit this digital data to one or more modules 202, 204, 206, 208, 210, 212 of the map module 197.

In the illustrated implementation shown in FIG. 2, the map module 197 includes a communication module 202, a network presence module 204, a network strength module 206, a network type module 208, a location module 210, and a builder module 212. These modules of the map module 197 are communicatively coupled to each other via the bus 220.

In some implementations, modules of the map module 197 can be stored in a single server or device. In some other implementations, modules of the map module 197 can be distributed and stored across multiple servers or devices. Furthermore, the separation of various components, modules, and servers in the implementations described herein should not be understood as requiring such separation in all implementations. In some implementations, the described components, modules, devices, or servers can generally be integrated together in a single component, module, device, or server.

In some implementations, each of the modules 202, 204, 206, 208, 210, and 212 in the map module 197 can be a set of instructions executable by the processor 225 to provide the functionality described below. In some other implementations, each of the modules 202, 204, 206, 208, 210, and 212 can be stored in the memory 227 and can be accessible and executable by the processor 225 of the system 200. Each of the modules 202, 204, 206, 208, 210, and 212 may be adapted for cooperation and communication with the processor 225 and other components of the system 200. In some implementations, each of the modules 202, 204, 206, 208, 210, and 212 may be adapted to function as one or more thin clients that are stored and executed by a processor of the system 200.

The communication module 202 can be software including routines for handling communications between the map module 197 and other components of the system 200. The communication module 202 may be communicatively coupled to the bus 220 via a signal line 222. The communication module 202 sends and receives data, via the communication unit 245, to and from one or more of the vehicle system 123, the mobile client system 188, the social network server 101, the content server 107, the update server 109, or the second server 177. For example, the communication module 202 receives, via the communication unit 245, the journey data 283 from the update server 109 and sends the journey data 283 to the memory 227.

In some implementations, the communication module 202 receives data from components of the map module 197 and stores the data in one or more of the storage 201 or the memory 227. In some implementations, the communication module 202 retrieves data from the storage 201 or the memory 227 and sends the data to one or more components of the map module 197. In some implementations, the communication module 202 may handle communications between components of the map module 197. For example, the communication module 202 receives data from one module and sends the data to another module.

The network presence module 204 can be software including routines for scanning for the presence of a wireless network and detecting the presence of a wireless network signal associated with the wireless network. The network presence module 204 may be communicatively coupled to the bus 220 via a signal line 224. The network presence module 204 may communicate with the sniffer 299 via the communication unit 245 to scan for the presence of a wireless network and to detect a wireless network signal associated with the wireless network.

The network strength module 206 can be software including routines for determining the strength of the wireless network signal. The network strength module 206 may be communicatively coupled to the bus 220 via a signal line 226. The network strength module 206 may communicate with the sniffer 299 via the communication unit 245 to determine the strength of the wireless network signal. For example, the network strength module 206 may determine the strength of the wireless network signal as one of excellent, good, fair, and weak.

The network type module 208 can be software including routines for determining a type of the wireless network signal. The network type module 208 may be communicatively coupled to the bus 220 via a signal line 280. The network type module 208 may communicate with the sniffer 299 via the communication unit 245 to determine the type of the wireless network signal. For example, the network type module 208 may determine the type of the wireless network signal as one of wireless fidelity (Wi-Fi), 3G, 4G, and Bluetooth.

The location module 210 can be software including routines for determining a location of the wireless network signal. The location module 210 may be communicatively coupled to the bus 220 via a signal line 228. The location module 210 may communicate with the sniffer 299 via the communication unit 245 to determine the location of the wireless network signal. For example, the location module 210 may determine the GPS location of the wireless network signal.

The builder module 212 can be software including routines for building a wireless network map. The builder module 212 may be communicatively coupled to the bus 220 via a signal line 230. The builder module 212 may receive the strength, the type, and the location of the wireless network signal from the network strength module 206, the network type module 208, and the location module 210, respectively. The builder module 212 may build a wireless network map including data describing the strength, the type, and the location of the detected wireless network signal. In some implementations, the wireless network map may include data describing strengths, types, and locations of detected wireless network signals in a geographic area. The wireless network map may include a wireless network coverage map and one or more dead zones in a geographic area.

### Example Transfer Module

Referring now to FIG. 3, an example of the transfer module 125 is shown in more detail. FIG. 3 is a block diagram of a system 300 that includes the transfer module 125, a processor 325, a communication unit 345, a storage 301, a navigation system 324, and a memory 327 according to some examples. The components of the system 300 are communicatively coupled by a bus 321. The system 300 may be one of the vehicle system 123, the mobile client system 188, and any other server in the system 100.

The processor 325 may have structure similar to the processor 225 and may provide functionality similar to the processor 225. The processor 325 is coupled to the bus 321 for communication with the other components via a signal line 348. The memory 327 may have structure similar to the memory 227 and may provide functionality similar to the memory 227. The memory 327 is coupled to the bus 321 for communication with the other components via a signal line 344. The communication unit 345 may have structure similar to the communication unit 245 and may provide functionality similar to the communication unit 245. The communication unit 345 is coupled to the bus 321 for communication with the other components via a signal line 346. The storage 301 may have structure similar to the storage 201 and may provide functionality similar to the storage 201. The storage 301 is coupled to the bus 321 for communication with the other components via a signal line 342. The description for the processor 325, the memory 327, the communication unit 345, and the storage 301 will not be repeated here.

In some embodiments, the system 300 may include code and routines configured to perform or control performance of one or more steps of the methods 400, 500, 600, 700, 800, 900, 1000 described below with reference to FIGS. 4-10 when executed by the processor 325. In some embodiments, the system 300 may be a special purpose processor-based computing device programmed to execute one or more steps of the methods 400, 500, 600, 700, 800, 900, 1000 described below with reference to FIGS. 4-10 when executed by the processor 325.

The memory 327 stores one or more of user profile data 399, velocity data 391, the time synchronicity data 285, dead zone data 389, the journey data 283, navigation map data 387, preference hierarchy data 393, mesh network data 385, the network map data 281, and sensor data 383.

The user profile data 399 may describe a user profile that includes, but is not limited to, a user name; user preferences; online activities (e.g., web browsing, video viewing, and any other online activity); offline activities (e.g., places visited by the user); habits; hobbies; demographic data; and music, movie, audio books, and other digital data accessed by the user, etc. The velocity data 391 may describe velocities of a mobile system on one or more roadways. The dead zone data 389 may describe one or more dead zones in a geographic area. For example, the dead zone data 389 may describe one or more roadway sections in which no wireless network signal is available.

The navigation map data 387 may describe a navigation map for a mobile system. The preference hierarchy data 393 may describe a user preference hierarchy that indicates which network services a user prefers during different times of the day and different days of the week. The preference hierarchy data 393 may also include data describing different network services a user prefers during different journeys. The mesh network data 385 may describe an ad-hoc mesh network including a first mobile system and one or more other mobile systems in proximity to the first mobile system. The sensor data 383 may include data generated by one or more sensors.

The navigation system 324 may be a system for providing navigation instructions. For example, the navigation system 324 may provide turn-by-turn navigation instructions to a user that operates a mobile system such as the vehicle system 123 or the mobile client system 188. In another example, the navigation system 324 may provide graphical navigation guidance to the user. The navigation system 324 is communicatively coupled to the bus 321 via a signal line 250.

In the illustrated implementation shown in FIG. 3, the transfer module 125 includes a communication module 302, a preference module 308, a journey module 310, a consumption module 312, a network coverage module 314, an estimation module 316, a notification module 318, an overlay module 320, and a mesh network module 322. These components of the transfer module 125 are communicatively coupled to each other via the bus 321.

In some implementations, modules of the transfer module 125 can be stored in a single server or device. In some other implementations, modules of the transfer module 125 can be distributed and stored across multiple servers or devices. Furthermore, the separation of various components, modules, and servers in the implementations described herein should not be understood as requiring such separation in all implementations. In some implementations, the described components, modules, devices, or servers can generally be integrated together in a single component, module, device, or server.

In some implementations, each of the modules 302, 308, 310, 312, 314, 316, 318, 320, and 322 in the transfer module 125 can be a set of instructions executable by the processor 325 to provide the functionality described below. In some other implementations, each of the modules 302, 308, 310, 312, 314, 316, 318, 320, and 322 can be stored in the memory 327 of the system 300 and can be accessible and executable by the processor 325. Each of the modules 302, 308, 310, 312, 314, 316, 318, 320, and 322 may be adapted for cooperation and communication with the processor 325 and other components of the system 300.

The communication module 302 can be software including routines for handling communications between the transfer module 125 and other components of the system 300. The communication module 302 may be communicatively coupled to the bus 321 via a signal line 323. The communication module 302 sends and receives data, via the communication unit 345, to and from other entities of the system 300. For example, the communication module 302 receives, via the communication unit 345, social network data from the social network server 101 and sends the social network data to the journey module 310. In some implementations, the communication module 302 receives data from components of the transfer module 125 and stores the data in one or more of the storage 301 and the memory 327. In some implementations, the communication module 302 retrieves data from the storage 301 or the memory 327 and sends the data to one or more components of the transfer module 125. In some implementations, the communication module 302 may handle communications between components of the transfer module 125.

The preference module 308 can be software including routines for building a user preference hierarchy describing network services preferred by a user. The preference module 308 may be communicatively coupled to the bus 321 via a signal line 328. In some implementations, the preference module 308 retrieves user profile data from one of the second server 117 or the social network server 101. The preference module 308 analyzes the user profile data to determine which network services are preferred by the user. In some implementations, the user may prefer different network services depending on the time of the day. For example, the user may prefer to listen to news in the morning and light music in the late afternoon. The preference module 308 may build a user preference hierarchy describing which network services the user prefers for different times of the day based on the time synchronicity data. Alternatively or additionally, the user may prefer different network services depending on the weather conditions. The preference module 308 may build a user preference hierarchy describing which network services the user prefers based on the weather conditions. The preference module 308 may store preference hierarchy data describing the user preference hierarchy in one or more of the storage 301 and the memory 327.

The journey module 310 can be software including routines for determining a present journey associated with a user or a mobile system (e.g., the vehicle system 123 or the mobile client system 188). The journey module 310 may be communicatively coupled to the bus 321 via a signal line 330. In some implementations, the journey module 310 receives historical journey data associated with the mobile system or the user from the memory 327 or the storage 301 and estimates a present journey for the mobile system or the user based on the historical journey data. For example, the journey module 310 estimates a departure time, a destination, a journey duration, a travel route, and other journey context data associated with the present journey.

In some implementations, the journey module 310 receives time synchronicity data from the memory 327 and determines a synchronized local time associated with the mobile system based on the time synchronicity data. The journey module 310 receives weather data and calendar data from the second server 177 and social network data from the social network server 101. The journey module 310 determines a present journey associated with the user or the mobile system based on one or more of the synchronized local time, the weather data, the calendar data, and the social network data.

In some implementations, the user may input data describing one or more journeys (e.g., one or more departure times and one or more destinations for the one or more journeys) using a user interface. The journey module 310 stores the data inputted by the user in the memory 327 or the storage 301.

In some implementations, the journey module 310 sends data describing the present journey to one or more of the consumption module 312, the network coverage module 314, and the estimation module 316. In some other implementations, the journey module 310 stores the data in the storage 301 or the memory 327.

The consumption module 312 can be software including routines for determining one or more network services consumed by a user during a journey. The consumption module 312 may be communicatively coupled to the bus 321 via a signal line 332. In some implementations, the consumption module 312 receives data describing a present journey from the journey module 310. The consumption module 312 retrieves preference hierarchy data associated with the user based on the present journey or time synchronicity data. The consumption module 312 determines one or more preferred network services for the user during the present journey based on context of the present journey or the preference hierarchy data. For example, assume the time synchronicity data indicates the present time is 6:30 PM. The present journey is a journey from work to home. The consumption module 312 determines that the user prefers to listen to the user's favorite radio station because the preference hierarchy data indicates that the user usually listens to his favorite radio station from 6:00 PM to 7:00 PM.

The network coverage module 314 can be software including routines for determining network coverage during a journey. The network coverage module 314 may be communicatively coupled to the bus 321 via a signal line 334. In some implementations, the network coverage module 314 retrieves network map data describing a wireless network coverage map along roadways of the present journey. The network coverage module 314 determines network coverage for the present journey based on the network map data. For example, the network coverage module 314 determines first roadway sections along the present journey where connectivity to one or more mobile data networks is available and dead zones where connectivity to the one or more mobile data networks is not available.

The estimation module 316 can be software including routines for estimating whether a mobile system will enter a dead zone. The estimation module 316 may be communicatively coupled to the bus 321 via a signal line 336. In some implementations, the estimation module 316 estimates whether the mobile system will travel into a dead zone during the present journey based on the network coverage along the present journey. For example, if a roadway section along the present journey includes a dead zone without network coverage, the estimation module 316 may estimate that the mobile system will travel into the dead zone.

Before the mobile system enters the dead zone, the estimation module 316 estimates an amount of data that can be transmitted to the mobile system based on the network map data and the journey data describing the present journey. The estimation module 316 determines network services data to enable the mobile system to consume the preferred network services while in the dead zone. The estimation module 316 transmits a request for the network services data to the content server 107, the update server 109, or the second server 177 so that the mobile system may retrieve the network services data before entering the dead zone. The network services data may be configured to enable the mobile system to consume the preferred network services while in the dead zone.

The notification module 318 can be software including routines for notifying a user of a dead zone. The notification module 318 may be communicatively coupled to the bus 321 via a signal line 338. In some implementations, the notification module 318 receives data from the estimation module 316 describing that the mobile system will travel into a dead zone. The notification module 318 may receive sensor data describing a present user activity. The notification module 318 determines whether the user is engaged in an interruptible activity. An interruptible activity may include an activity that can be interrupted. For example, if a user activity describes that the user is driving a vehicle to merge into a highway, the user may need to focus on the driving activity and may not be disturbed. However, if the user activity describes the user is driving the vehicle along a highway, the user activity may be interruptible.

If the user is engaged in an interruptible activity, the notification module 318 may notify the user of a dead zone along the present journey. For example, the notification module 318 may provide the user with an indication describing that the mobile system will travel into a dead zone during the present journey.

The overlay module 320 can be software including routines for overlaying an indication of a dead zone on a navigation map. The overlay module 320 may be communicatively coupled to the bus 321 via a signal line 340. In some implementations, the overlay module 320 receives data from the estimation module 316 describing that the mobile system will travel into a dead zone during the present journey. The overlay module 320 determines that the mobile system is presently providing a graphical navigation guidance such as a navigation map to the user. The overlay module 320 may generate graphical data depicting the dead zone for a geographic region associated with present journey and may overlay an indication of the dead zone on the graphical navigation guidance. As a result, the user may be informed of the dead zone from the graphical navigation guidance.

The mesh network module 322 can be software including routines for transferring network services data using an ad-hoc mesh network. The mesh network module 322 may be communicatively coupled to the bus 321 via the signal line 342. In some implementations, the mesh network module 322 receives data describing the mobile system will travel into a dead zone from the estimation module 316. The mesh network module 322 detects presence of nearby mobile systems and builds an ad-hoc mesh network among the nearby mobile systems. The mesh network module 322 may transmit or receive network services data among the mobile systems of the ad-hoc mesh network. For example, the mesh network module 322 may receive network services data from other mobile systems in the ad-hoc mesh network.

An example use of the map module 197 and the transfer module 125 may include building a wireless network map such as a dynamic roadway cell phone coverage map. A dead zone may include an area of the map that does not have 3G or 4G service. The transfer module 125 may estimate when a vehicle is going to enter a dead zone, how long the vehicle will be in the dead zone, and what content the driver would like to consume while the vehicle is in the dead zone. The transfer module 125 may proactively deliver content to the vehicle before the vehicle enters the dead zone. In this way, the transfer module 125 enables the driver to access network services while driving in a dead zone.

In some implementations, the transfer module 125 may wirelessly pre-fetch data for a vehicle's network services based on a wireless network map (e.g., a roadway cell phone coverage map) that is dynamic and automatically changes for different times of day or weather conditions. The changes may occur in real time. The transfer module 125 may use the dynamic roadway cell phone coverage map to determine that a vehicle is going to leave an area that has a cell phone reception signal with strength equal to or greater than a threshold and to enter an area having a cell phone reception signal with strength less than the threshold. The transfer module 125 uses the dynamic roadway cell phone coverage map to determine how much cellular data can be pushed to the vehicle for a given time period based on map data and journey data. The transfer module 125 may push the data to the vehicle based on the driver's historic preferences before entering the dead zone so that the driver can access their preferred content while driving in a dead zone.

### Methods

Referring now to FIG. 4, an example of a method 400 for determining network map data describing one or more wireless network signals for a geographic region is described. The network presence module 204 scans 402 for presence of a wireless network. The network presence module 204 detects 404 presence of a wireless network signal associated with the wireless network. The network strength module 206 determines 406 a strength of the wireless network signal. The network type module 208 determines 408 a type of the wireless network signal. The location module 210 determines 410 a GPS location associated with the wireless network signal. The builder module 212 stores 412 network map data describing the detected wireless network signal and the GPS location. The builder module 212 builds 414 a network map describing the wireless network signal for a geographic region. The builder module 212 stores 416 the network map.

FIG. 5 is a flowchart of an example method 500 for determining preference hierarchy data. The preference module 308 retrieves 502 user profile data associated with a user and analyzes 504 the user profile data to determine which network services are preferred by the user. The journey module 310 determines 506 a present journey based on time synchronicity data and historical journey data associated with the user. The preference module 308 determines 508 which network services the user prefers for different times of the day based on the time synchronicity data. The preference module 308 builds 510 a user preference hierarchy describing which network services the user prefers for the different times of the day. The preference module 308 stores 512 preference hierarchy data describing the user preference hierarchy.

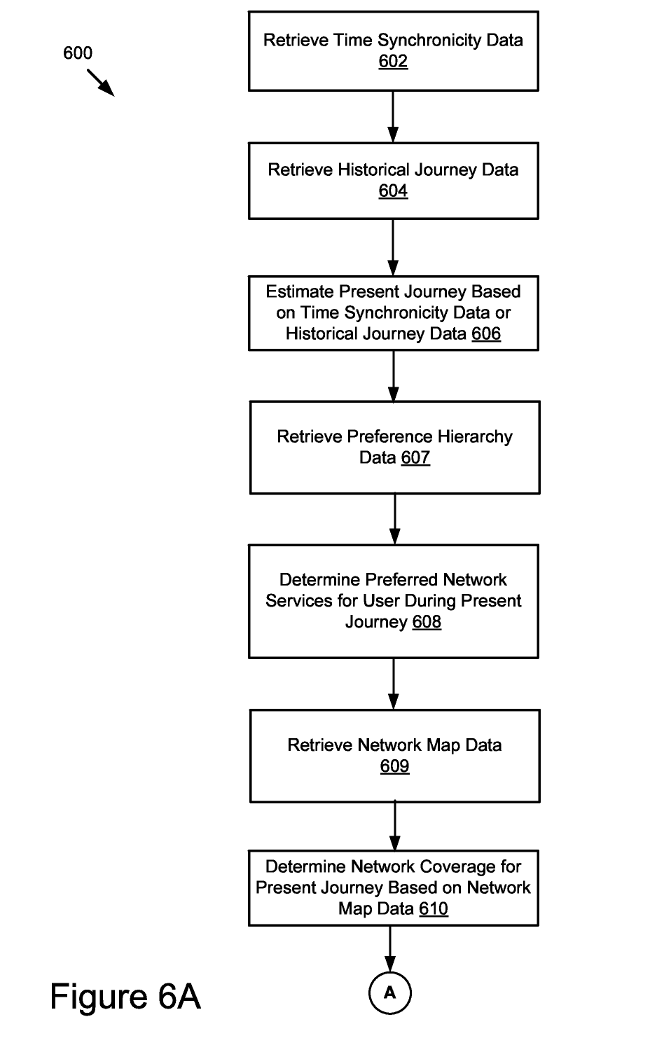

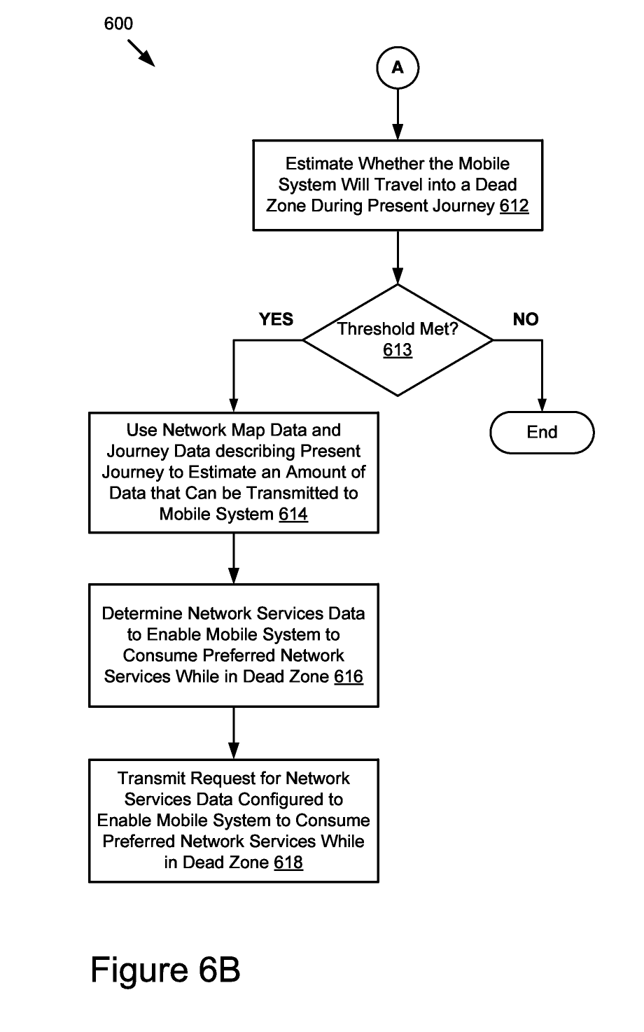

FIGS. 6A and 6B are a flowchart of an example method 600 for proactively transferring network services data using network map data. Referring to FIG. 6A, the communication module 302 retrieves 602 time synchronicity data. The communication module 302 retrieves 604 historical journey data. The journey module 310 estimates 606 a present journey associated with a mobile system based on the time synchronicity data or the historical journey data. The communication module 302 retrieves 607 preference hierarchy data based on the present journey or the time synchronicity data. The consumption module 312 determines 608 preferred network services for the user during the present journey based on the preference hierarchy data. The communication module 302 retrieves 609 network map data based on the present journey. The network coverage module 314 determines 610 network coverage for the present journey based on the network map data.

Referring to FIG. 6B, the estimation module 316 estimates 612 whether the mobile system will travel into a dead zone during the present journey. The estimation module 316 determines 613 whether a threshold is met. For example, the estimation module 316 determines whether a duration during which the mobile system travels in the dead zone is greater than a predetermined threshold such as two minutes. If the threshold is met, the estimation module 316 uses 614 the network map data and the journey data describing the present journey to estimate an amount of data that can be transmitted to the mobile system. The estimation module 316 determines 616 network services data to enable the mobile system to consume the preferred network services while in the dead zone. The estimation module 316 transmits 618 a request for the network services data configured to enable the mobile system to consume the preferred network services while in the dead zone.

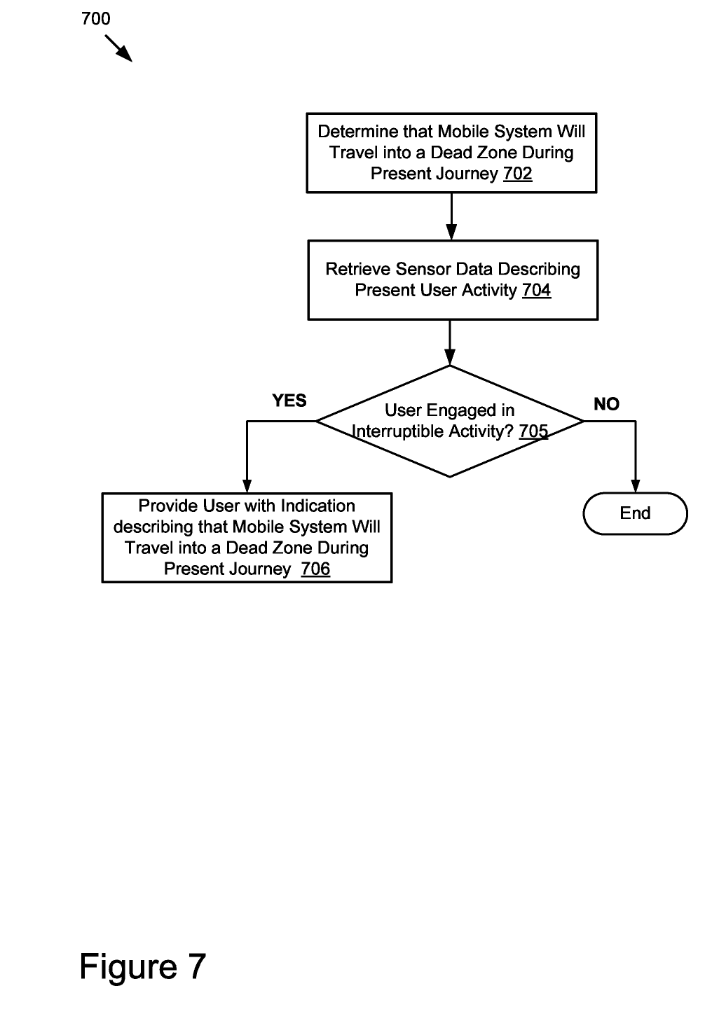

FIG. 7 is a flowchart of an example method 700 for providing a user with an indication that a mobile system will travel into a dead zone during a present journey. The estimation module 316 determines 702 that the mobile system will travel into a dead zone during the present journey. The communication module 302 retrieves 704 sensor data describing a present user activity. The notification module 318 determines 705 whether the user is engaged in an interruptible activity based on the sensor data. If the user is engaged in an interruptible activity, the notification module 318 provides 706 the user with an indication describing that the mobile system will travel into a dead zone during the present journey.

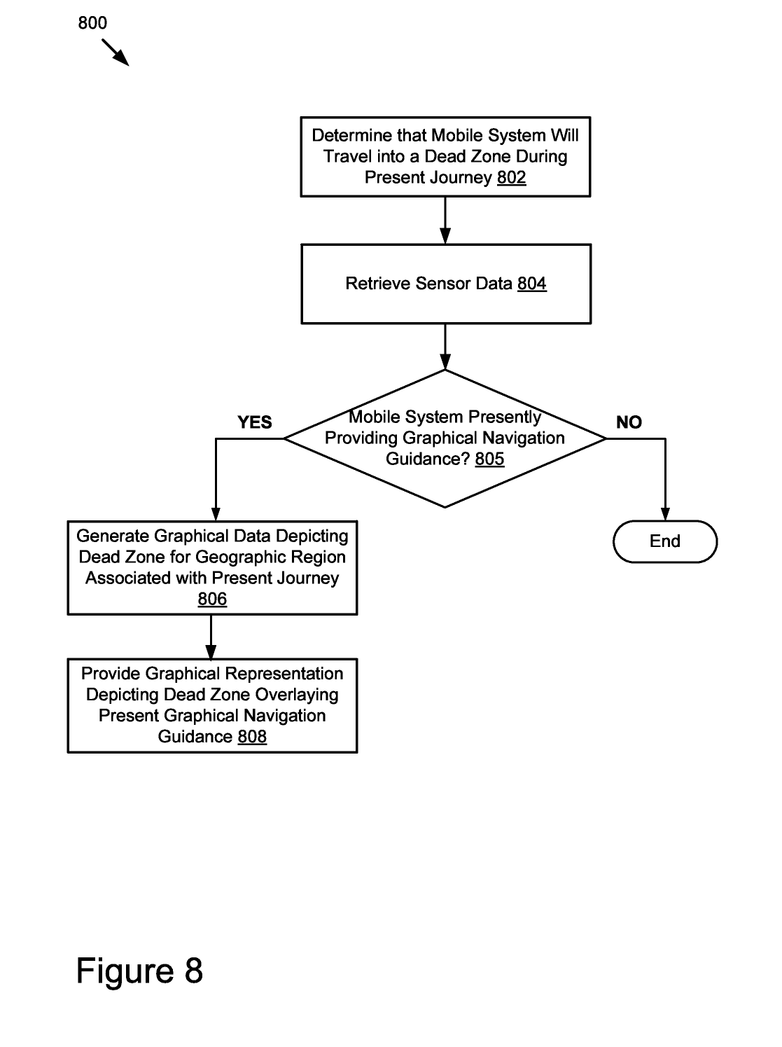

FIG. 8 is a flowchart of an example method 800 for providing a graphical representation depicting a dead zone for a geographic region overlaying present graphical navigation guidance requested by a user. The estimation module 316 determines 802 that the mobile system will travel into a dead zone during the present journey. The communication module 302 retrieves 804 sensor data. The overlay module 320 determines 805 whether the mobile system is presently providing graphical navigation guidance to the user based on the sensor data. If the mobile system is presently providing graphical navigation guidance to the user, the overlay module 320 generates 806 graphical data depicting the dead zone for a geographic region associated with present journey. The overlay module 320 provides 808 a graphical representation depicting the dead zone overlaying the present graphical navigation guidance.

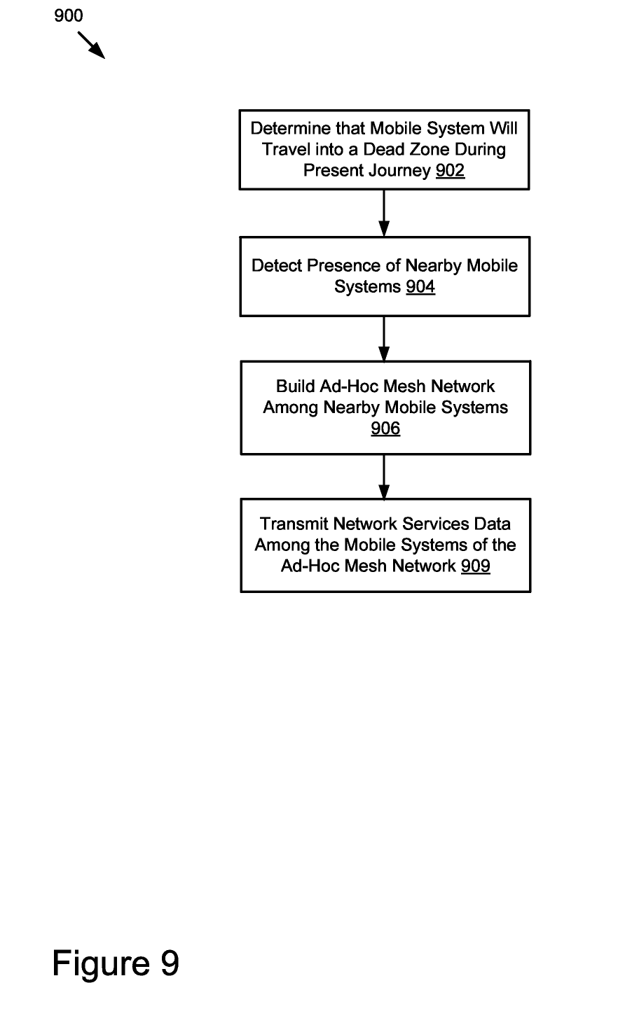

FIG. 9 is a flowchart of an example method 900 for providing network services data via an ad-hoc mesh network. The estimation module 316 determines 902 that a mobile system will travel into a dead zone during a present journey. The mesh network module 322 detects 904 presence of nearby mobile systems. The mesh network module 322 builds 906 an ad-hoc mesh network among nearby mobile systems. The mesh network module 322 transmits 909 network services data among the mobile systems of the ad-hoc mesh network.

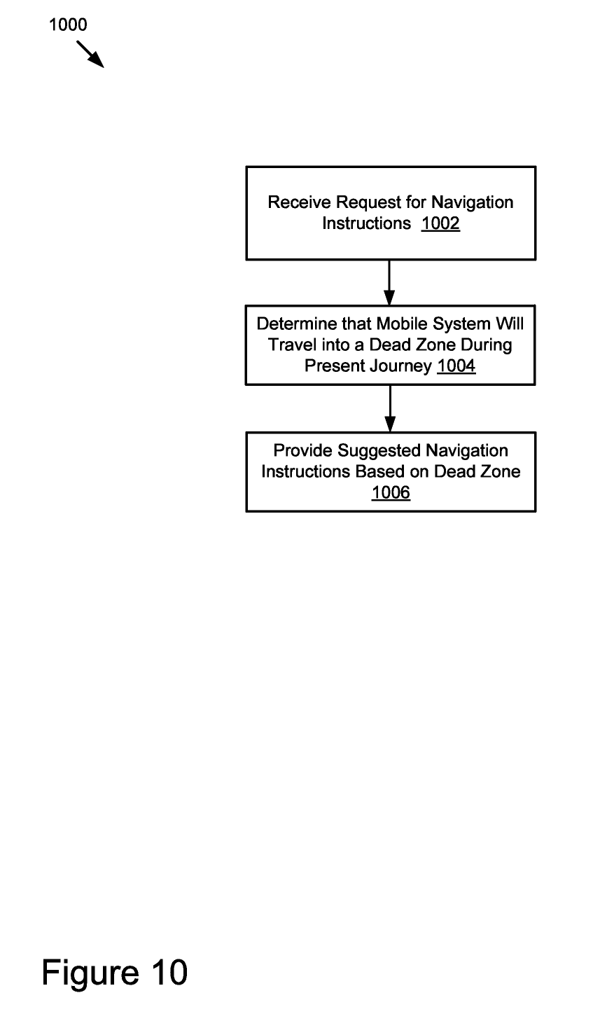

FIG. 10 is a flowchart of an example method 1000 for suggested navigation instructions configured to minimize a journey duration in a dead zone. The communication module 302 receives 1002 a request for navigation instructions. The estimation module 316 determines 1004 that the mobile system will travel into a dead zone during a present journey. The notification module 318 provides 1006 suggested navigation instructions to the user based on the dead zone so that the mobile system may travel on a route with a reduced travel time in the dead zone.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the present implementations can be described above primarily with reference to user interfaces and particular hardware. However, the present implementations can apply to any type of computing device that can receive data and commands, and any peripheral devices providing services.

Reference in the specification to “some implementations” or “some instances” means that a particular feature, structure, or characteristic described in connection with the implementations or instances can be included in at least one implementation of the description. The appearances of the phrase “in some implementations” in various places in the specification are not necessarily all referring to the same implementations.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present implementations of the specification can also relate to an apparatus for performing the operations herein. This apparatus may be specially constructed for the required purposes, or it may include a general-purpose computer selectively activated or reconfigured by a computer program stored in the computer. Such a computer program may be stored in a computer-readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory, or any type of media suitable for storing electronic instructions, each coupled to a computer system bus.

The specification can take the form of some entirely hardware implementations, some entirely software implementations, or some implementations containing both hardware and software elements. In some preferred implementations, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including, but not limited to, keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the specification as described herein.

The foregoing description of the implementations of the specification has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies, and other aspects are not mandatory or significant, and the mechanisms that implement the specification or its features may have different names, divisions, or formats. Furthermore, as will be apparent to one of ordinary skill in the relevant art, the modules, routines, features, attributes, methodologies, and other aspects of the disclosure can be implemented as software, hardware, firmware, or any combination of the three. Also, wherever a component, an example of which is a module, of the specification is implemented as software, the component can be implemented as a standalone program, as part of a larger program, as a plurality of separate programs, as a statically or dynamically linked library, as a kernel-loadable module, as a device driver, or in every and any other way known now or in the future to those of ordinary skill in the art of computer programming. Additionally, the disclosure is in no way limited to implementation in any specific programming language, or for any specific operating system or environment. Accordingly, the disclosure is intended to be illustrative, but not limiting, of the scope of the specification, which is set forth in the following claims.

What is claimed is:

1. A computer-implemented method comprising:
estimating a present journey for a user based on time synchronicity data and historical journey data;
determining one or more preferred network services for the user based on preference hierarchy data;
determining that a mobile system associated with the user will enter a dead zone based on the estimation of the present journey and network map data describing the dead zone, wherein the dead zone is a geographic area having limited connectivity to a mobile data network;
determining, by a processor-based computing device programmed to perform the determining, network services data configured to enable the mobile system to consume the one or more preferred network services while in the dead zone; and
transmitting a request for network services data configured to enable the mobile system to consume the one or more preferred network services while in the dead zone.

2. The method of claim 1, wherein the time synchronicity data is associated with the mobile system and describes a universal time shared among a distributed network including two or more mobile systems.

3. The method of claim 1, wherein the historical journey data is associated with the user and describes one or more prior journeys taken by the user.

4. The method of claim 1, wherein the historical journey data is associated with the user and the mobile system downloads the historical journey data for the user from a network.

5. The method of claim 1, wherein the mobile system is one of a vehicle, a robot, a smartphone, a laptop, a tablet computing device, and a connected device.

6. The method of claim 1, wherein the preference hierarchy data describes which network services the user is estimated to prefer for a time of day indicated by the time synchronicity data.

7. The method of claim 1, wherein the preference hierarchy data describes which network services the user is estimated to prefer for the present journey.

8. The method of claim 1, further comprising determining that the user is on a phone call and providing the user with an indication that the mobile system will travel into a dead zone during the present journey, the indication provided before the mobile system enters the dead zone.

9. The method of claim 1, further comprising:
determining that the mobile system is providing graphical navigation instructions;
generating graphical data configured to depict one or more dead zones for a geographical region associated with the graphical navigation instructions, wherein the graphical data is generated responsive to determining that the mobile system will enter the dead zone; and
providing a graphical representation of the one or more dead zones as a component of the graphical navigation instructions.

10. The method of claim 1, further comprising:
detecting the presence of one or more nearby mobile systems responsive to determining that the mobile system will enter the dead zone;
building an ad-hoc mesh network including the mobile system and the detected one or more nearby mobile systems; and
transmitting network services data among entities of the ad-hoc mesh network, the transmission enabling the entities of the ad-hoc mesh network that are in the dead zone to continue receiving network services data while in the dead zone.

11. The method of claim 1, further comprising providing navigation instructions configured to minimize a journey duration in the dead zone responsive to determining that the mobile system will enter the dead zone.

12. A non-transitory computer-readable medium having computer instructions stored thereon that are executable by a processing device to perform or control performance of operations comprising:
estimating a present journey for a user based on time synchronicity data and historical journey data;
determining one or more preferred network services for the user based on preference hierarchy data;
determining that a mobile system associated with the user will enter a dead zone based on the estimation of the present journey and network map data describing the dead zone, wherein the dead zone is a geographic area having limited connectivity to a mobile data network;
determining network services data configured to enable the mobile system to consume the one or more preferred network services while in the dead zone; and
transmitting a request for network services data configured to enable the mobile system to consume the one or more preferred network services while in the dead zone.

13. The non-transitory computer-readable medium of claim 12, wherein the time synchronicity data is associated with the mobile system and describes a universal time shared among a distributed network including two or more mobile systems.

14. The non-transitory computer-readable medium of claim 12, wherein the historical journey data is associated with the user and describes one or more prior journeys taken by the user.

15. The non-transitory computer-readable medium of claim 12, wherein the historical journey data is associated with the user and the mobile system downloads the historical journey data for the user from a network.

16. The non-transitory computer-readable medium of claim 12, wherein the mobile system is one of a vehicle, a robot, a smartphone, a laptop, a tablet computing device, and a connected device.

17. The non-transitory computer-readable medium of claim 12, wherein the preference hierarchy data describes which network services the user is estimated to prefer for a time of day indicated by the time synchronicity data.

18. The non-transitory computer-readable medium of claim 12, wherein the preference hierarchy data describes which network services the user is estimated to prefer for the present journey.

19. A system comprising:
a processor; and
a non-transitory memory storing instructions that, when executed by the processor, cause the system to:
estimate a present journey for a user based on time synchronicity data and historical journey data;
determine one or more preferred network services for the user based on preference hierarchy data;
determine that a mobile system associated with the user will enter a dead zone based on the estimation of the present journey and network map data describing the dead zone, wherein the dead zone is a geographic area having limited connectivity to a mobile data network;
determine network services data configured to enable the mobile system to consume the one or more preferred network services while in the dead zone; and
transmit a request for network services data configured to enable the mobile system to consume the one or more preferred network services while in the dead zone.

20. The system of claim 19, wherein the time synchronicity data is associated with the mobile system and describes a universal time shared among a distributed network including two or more mobile systems.

21. The system of claim 19, wherein the historical journey data is associated with the user and describes one or more prior journeys taken by the user.

22. The system of claim 19, wherein the historical journey data is associated with the user and the mobile system downloads the historical journey data for the user from a network.

23. The system of claim 19, wherein the mobile system is one of a vehicle, a robot, a smartphone, a laptop, a tablet computing device, and a connected device.

24. The system of claim 19, wherein the preference hierarchy data describes which network services the user is estimated to prefer for a time of day indicated by the time synchronicity data.

25. The system of claim 19, wherein the preference hierarchy data describes which network services the user is estimated to prefer for the present journey.
